(19) United States
(12) Patent Application Publication
(10) Pub. No.: US 2014/0245337 A1
(43) Pub. Date: Aug. 28, 2014

(54) Proxy Analytics

(71) Applicants: Andrew Gildfind, Brixton (GB); Simon M. Rowe, Berkshire (GB)

(72) Inventors: Andrew Gildfind, Brixton (GB); Simon M. Rowe, Berkshire (GB)

(73) Assignee: GOOGLE INC., Mountain View, CA (US)

(21) Appl. No.: 13/191,860

(22) Filed: Jul. 27, 2011

(51) Int. Cl. H04H 60/32

(52) U.S. Cl. 725/16

(57) ABSTRACT

Methods, systems, and apparatus, including computer programs encoded on a computer storage medium, for analyzing behavioral data. In one aspect, a method includes receiving a request for television reporting sample data from a client device. The request includes filtering criteria. The television reporting data comprises channel tune event data and viewership data. In response to receiving the request, processing the television reporting data to identify filtered data from the television reporting data satisfying the filtering criteria; processing the filtered data to generate filtered sample data; and associating the filtered sample data with channel tune event data and viewership data to generate the television reporting sample data. The method also includes providing the television reporting sample data to the client device and receiving processing parameters from the client device, and, in response to receiving the processing parameters, processing the filtered data based on the processing parameters to generate reporting data metric results.

### BACKGROUND

This specification generally relates to data analysis.

Data analysis generally describes the process of manipulating, inspecting, transforming or otherwise processing data into a form or structure that conveys useful or desired information. For example, analyzing consumer television viewership data (e.g., from television set top boxes or consumer surveys) can provide insight into viewership patterns and viewer interests.

Data analysis can be conducted in myriad ways. For example, data analysis can be conducted through the use of online analytics systems. These online analytics systems are capable of processing vast amounts of raw data. To reduce the quantity of stored data (and mitigate the cost and complexity associated with the infrastructure required to manage such large quantities of data) some of these systems use batch processes to compute metrics from the raw data and store only the results of the computed metrics for later access. These systems do not retain the raw data. Such systems are efficient at returning query results directed to those pre-computed metrics but, because the underlying raw data is not readily accessible, are limited with respect to generating results for metrics outside those pre-computed during the batch processing.

Other online analytics systems retain and permit access to the raw data. These systems provide users the flexibility to obtain results for user-defined metrics, as opposed to only the pre-defined metrics in systems that do not retain the raw data. Because these systems can process the raw data on a query-by-query basis the data are stored, for example, in a pre-encoded form optimized for processing vast quantities of data. Thus these systems cannot readily process data that is not encoded and accessible in a similar fashion (e.g., data stored local to a specific user that the user desires to join with the system data for the analysis process). Furthermore, in some scenarios a user may not want to join the user's data to the pre-encoded raw data or otherwise share the user's data with the analytics systems, e.g., if the user's local data is confidential.

Even with such pre-encoding processing, the processing of queries is computationally intensive (e.g., requires massively parallel scans across many databases storing the raw data). The strains on these systems are compounded when users run numerous exploratory queries attempting to identify metrics that provide the desired insight. For example, a user may run multiple queries, many of which do not provide useful information, before the user constructs a query that obtains useful results that identify a trend in the data (e.g., a trend previously unknown to the user).

In some scenarios the computational resources required on online analytics systems can be reduced by passing the data to users to process on local user systems. However, this mitigating option is not readily available for analytics systems that process raw data, as the timely transfer of such large amounts of data to local user machines requires large bandwidth commitments. Additionally, even if the data can be transferred in a timely fashion, most local user systems lack the computational resources to process the raw data in a timely manner.

### SUMMARY

In general, one innovative aspect of the subject matter described in this specification can be embodied in methods that include the actions of receiving a request for television reporting sample data from a client device. The request includes filtering criteria and the television reporting sample data is a subset of television reporting data. The television reporting data comprises channel tune event data specifying channel tune states of viewing devices at certain times and viewership data specifying viewership characteristics associated with the viewing devices. In response to receiving the request, processing the television reporting data to identify filtered data from the television reporting data satisfying the filtering criteria; processing the filtered data to generate filtered sample data, wherein the filtered sample data is a statistically representative sample of the filtered data; and associating the filtered sample data with channel tune event data and viewership data related to the filtered sample data to generate the television reporting sample data. The methods also include the actions providing the television reporting sample data to the client device and receiving processing parameters from the client device. The processing parameters define one or more operations performed on the television reporting sample data at the client device. In response to receiving the processing parameters, processing the filtered data based on the processing parameters to generate reporting data metric results. Other embodiments of this aspect include corresponding systems, apparatus, and computer programs, configured to perform the actions of the methods, encoded on computer storage devices.

Particular embodiments of the subject matter described in this specification can be implemented to realize one or more of the following advantages. Using the resources of the client as an analytics proxy permits users to join data stored by online analytics systems with private or confidential data held by the user for data analysis without sharing the user information with the system. This provides an added level of protection for information the user considers to be confidential and/or sensitive information. Using the resources of the client also permits users to develop and refine user-defined queries locally at the user's system without burdening the analytics system. Users can then pass the refined queries to the analytics system for processing. It further permits users to utilize tools local to the users' systems to analyze the data as opposed to only the tools available from the online analytics systems.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an environment in which an analytics system is utilized.

FIG. 2 is a block diagram of an example analytics system.

FIG. 3A is a flow diagram of an example process for analyzing data.

FIG. 3B is an illustration of example television reporting data.

FIG. 4 is a flow diagram of an example process for generating processing parameters

FIG. 5 is a flow diagram of an example process for providing confidence data.

FIG. 6 is a block diagram of a programmable processing system.

Like reference numbers and designations in the various drawings indicate like elements.

### DETAILED DESCRIPTION

System Overview

This written description describes methods, software and systems for processing and analyzing data in an online analytics system based on processing parameters developed locally at a client device of a user of the online analytics system. For example, the analytics system can pass statistically representative samples of raw data held by the analytics system to a user's local computer system. The user can then develop and refine data filters and queries (e.g., processing parameters) at the user's system based on the data samples. Once the user has developed the filters and queries the user deems to be useful, the user can pass the defined filters and queries to the system for processing on the entire data set. The analytics system can then make the results from the entire data set available to the user.

By selecting statistically representative samples of raw data and providing the samples to the user device, the analytics system conserves its processing resources for queries and filters that the user is most likely to find useful. The user, in term, can define the queries and filters in a more timely manner, as the processing of the samples locally at the client device generates sample results more quickly than if the entire data set were being processed at the analytics system for each scenario the user attempts.

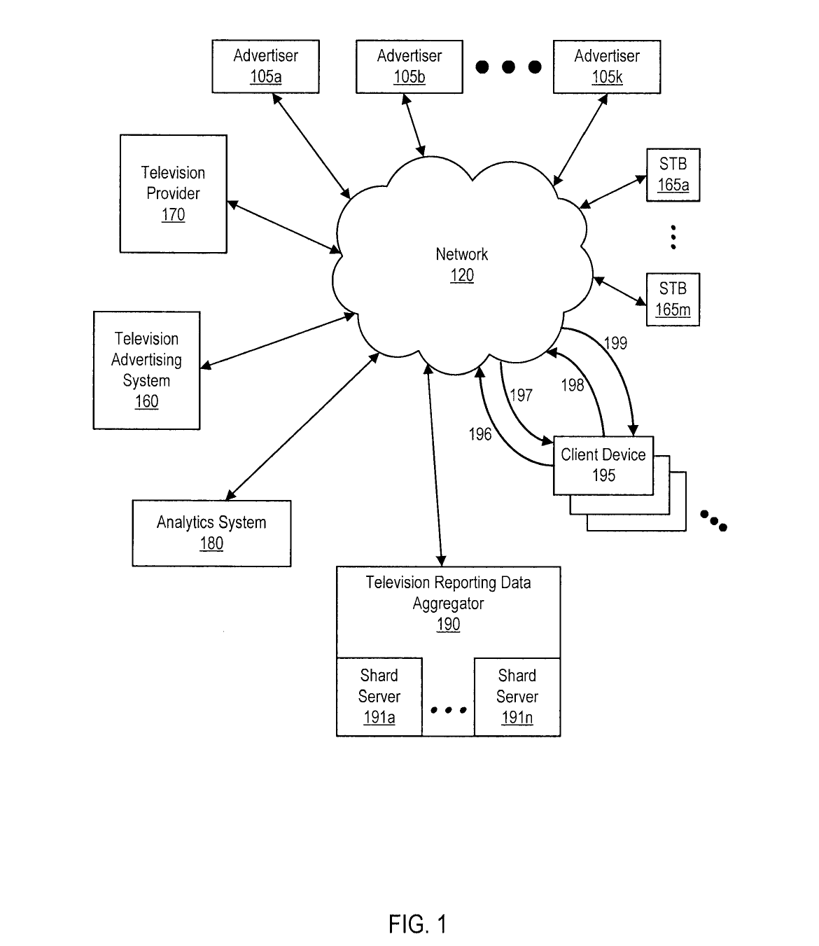

FIG. 1 is a block diagram of an environment 100 in which an analytics system 180 is utilized. The network 120 can be composed of multiple different types of networks. Example network types include local area networks (LANs), wide area networks (WANs), telephonic networks, and wireless networks (e.g., 802.11x compliant networks, satellite networks, cellular networks, etc.). Although only one advertising system (160), three advertisers (105a, 105b, and 105k) and two television processing devices (165a and 165m) are shown, the television advertising environment 100 may include many more advertisers, television processing devices and television advertising systems.

The television provider 170 can, for example, be a cable network provider, a satellite television provider, or other provider of television programming. The television processing devices 165a and 165m (collectively referenced as 165) are devices that decode encoded content the television provider 170 provides, enabling the content to be viewed upon a television device. For example, the decoder provided by a digital satellite provider is a set top box that enables the content provided by the digital satellite provider to be viewed upon a television device.

The television advertising system 160 can receive television advertisements and advertisement campaign data from the advertisers 105, and coordinate the provisioning of the advertisements with the television provider 170. The television advertising system 160, for example, identifies relevant advertising for airtime advertisement spots of the television provider 170. The television advertising system 160 can, for example, select candidate advertisements to air during an advertisement availability based on account advertiser bids, budgets, and any quality metrics that have been collected, e.g., viewer actions, impressions, etc. For example, advertisements can be selected to air during the advertisement availability according to a computer-implemented auction.

The television processing devices 165 can report back to the television provider system 170 various information, such as channel tune records that describe a channel change from a first channel to a second channel, the time of the change, and, optionally, the content being broadcast on one or both channels during the channel tune. The television processing devices 165 are also associated with viewer demographic information based upon subscriber information. The television provider system 170 can provide the reporting data provided by the television processing devices 165 to the television advertising system 160 and the television reporting data aggregator 190.

The television reporting data aggregator 190 is a data aggregation system that receives and stores television reporting data including low level television reporting data (e.g., raw reporting data) such as channel tune records including time-stamped events, logging information and corresponding processing device 165 identifiers.

The television reporting data aggregator 190 can store large quantities of this low level television reporting data in pre-encoded forms that are designed to be efficiently scanned. In some implementations, the television reporting data aggregator 190 is a sharded data storage system that includes shard servers 191. Sharding is a method of partitioning a set of data, and each partition is referred to as a shard. Each shard server 191 is responsible for processing a shard of the television reporting data, i.e., a subset of the television reporting data. While each shard server 191 stores and processes only a subset of the television reporting data, collectively, the shard servers 191 store and process all of the television reporting data.

The television reporting data aggregator 190 can use hashing functions or algorithms to partition and distribute the television reporting data into individual shard servers 191 without introducing any significant statistical biases into the partitioned data. For example, the television reporting data aggregator 190 can partition (e.g., by use of a hashing function applied to set to box identifiers) the television reporting data into non-overlapping subsets of television reporting data so that each subset is stored in a different data shard server 191. Such partitioning reduces any statistical bias that would otherwise result if the subsets were partitioned by demographics, DMA's, or other statistically significant parameter. Accordingly, assuming the data subsets are sufficiently large, any trends observed in the television reporting data will likely, although not necessarily, be reflected in each of the sharded subsets. Likewise, an analysis of data in any of the subsets will likely, although not necessarily, indicate trends not present in a holistic analysis of the television reporting data.

The advertisers 105 often need to review the performance of their advertising campaigns to determine the effectiveness of the campaigns, to identify new advertising targets (e.g., advertisement spots during particular television programs or time slots, on particular broadcast networks or to particular demographics) or to identify viewership patterns. There are a variety of tools that can be used to accomplish these goals. One such tool is the online data analytics system 180.

The analytics system 180 can be integrated with the television advertising system 160 or the television reporting data aggregator 190, or can be separate from but in data communication with the advertising system 160 and television reporting data aggregator 190. The analytics system 180 has access to the television reporting data. For example, the analytics system 180 can access the television reporting data stored and maintained by the television reporting data aggregator 190 (or shard servers 191). To access the data, the analytics system 180 can, for example, issue queries to the television reporting data aggregator 190 or shard servers 191 requesting portions of the television reporting data (e.g., the portion of the reporting data associated with viewers in New York).

Authorized users (e.g., advertisers registered with the advertising system 160) can utilize the analytics system 180 to analyze the television reporting data to, for example, determine trends in the television reporting data or to identify characteristics of the viewing population. Authorized users can use client devices 195 to access the analytics system 180. Client devices 195 include, for example, desktop and laptop computers and the like. An advertiser, for example, can use the advertiser's personal desktop computer 195 to access the analytics system 180 through web-based application programming interfaces (API). Such APIs can employ, for example, standard URL, parameters or human readable query languages such as JSON to facilitate data communications between the analytics system 180 and the client devices 195.

In some implementations, a client device 195 (e.g., at the direction of an advertiser user) sends a request 196 to the analytics system 180 requesting television reporting sample data. Television reporting sample data is a subset of the television reporting data (e.g., a subset of the television reporting data of particular interest to the advertiser). The request 196 includes data specifying filtering criteria. Filtering criteria data specify the criteria to be used to generate the television reporting sampling data. For example, the filtering criteria data can specify that the advertiser requests only television reporting data associated with 18-34 year old males (e.g., the television reporting sample data) or only data associated with viewing devices 165 in a particular geographic region.

In response to the request 196, the analytics system 180 provides to the client device 195 response 197 with the requested television reporting sample data or a subset thereof (e.g., the portion of television reporting data from 18-34 year old males). In some implementations, the analytics system 180 accesses the television reporting sample data from the television reporting data aggregator 190 and passes the accessed sample data to the client device 195. The television reporting sample data can be a statistically representative sample of the requested television reporting data. The television reporting sample data is statistically representative of the television reporting data if the relationships specified by the data in the television reporting data are also specified or substantially specified by the data in the television reporting sample data (e.g., as determined by a specified confidence threshold such as error bars or a p-value).

An advertiser can use the client device 195 to process and analyze the television reporting sample data received through the response 197. For example, advertisers can use analytics tools available on client devices 195 to analyze the reporting sample data (e.g., tools the advertiser is familiar with). The advertiser can develop, run and refine queries and filters on the television reporting sample data by use of the client device 195. This type of exploratory analysis (e.g., trial and error process) permits, for example, the advertiser to iterate through multiple queries and filters to identify queries and filters that return results that provide the desired insight locally at the client device 195. This local analysis helps to avoid the latency effects attendant with repeated exchanges with the analytics system 180, if such an exploratory and iterative process was handled remotely by the analytics system 180.

Once the advertiser has developed processing parameters (e.g., a query or set of queries and filters) that return results for desired metrics from the sample data, the advertiser, by use of the client device 195, can submit the possessing parameters to the analytics system 180 through an analysis request 198. The request 198 causes the analytics system 180 to analyze the television reporting data (or some portion of the television data) based on the processing parameters. For example, based on the advertiser's exploratory analyses on the television reporting sample data, the advertiser generated processing parameters to identify viewing devices tuned to a particular channel during four specific, different time periods. The advertiser can cause the request 198 to be submitted to the analytics system 180 so that the data analysis can be run at full precision on the largest available dataset available, e.g., the television reporting data set, as opposed to only on the sampled data set.

In response to performing the analysis specified by request 198, the analytics system 180 can send a response 199 to the client device 195 including results data from the analysis for review by the advertiser.

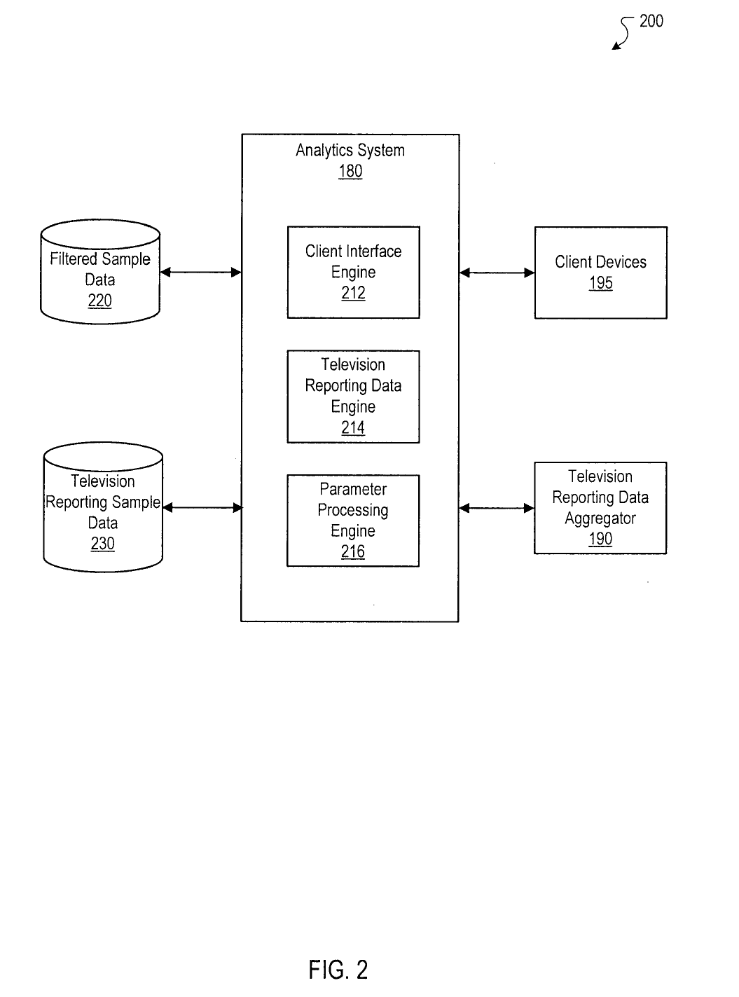

FIG. 2 is a block diagram of an example analytics system 180. The analytics system 180 includes a client interface engine 212, a television reporting data engine 214 and a parameter processing engine 216. The client interface engine 212 provides an interface through which the client device 195 and the analytics system 180 communicate to allow a user of the client device to access the analytics system 180. In some implementations, the client interface engine 212 is one or more application specific interfaces. The client interface engine 212, for example, permits the exchange of communications 196, 197, 198 and 199 between the analytics system 180 and the client devices 195 described above.

The television reporting data engine 214 is configured to process television reporting data to generate television reporting sample data based on a subset of filtered data (i.e., filtered sample data). The filtered sample data is a sampled subset of the television reporting data that satisfies the filtering criteria (e.g., a statistically representative sample of the subset). For example, if the filtering criteria specifies only data associated with viewing devices 165 that presented a certain television program then the television reporting data engine 214 identifies (or causes to be identified) television reporting data that satisfies the criterion (i.e., filtered data) and samples (or causes to be sampled) that filtered data to generate or identify the filtered sample data subset. The filtered sample data is stored in the filtered sample data store 220.

As described in more detail below, the television reporting sample data is derived from the filtered sample data. The television sample reporting data is the filtered sample data and all other data in the television reporting data that is related to the data in the filtered sample data. For example, the television reporting data includes identifiers of viewing devices 165 that presented a certain television program (e.g., filtered sample data) and channel tune states and channel tune times from those viewing devices 165 (e.g., data that is related to the data in the filtered sample data). The television reporting sample data is stored in the television reporting sample data store 230.

The parameter processing engine 216 is configured to process television reporting data based on the processing parameters received from the client device 195. For example, the queries developed and refined by a user (e.g., processing parameters) based on analyses of the television reporting sample data are provided to the parameter processing engine 216, via the client interface engine 212, and the parameter processing engine 216 processes (or causes to be processed) the television reporting data (or portions thereof) based on the processing parameters. The results from this process are, for example, returned to the client device 195, via client interface engine 212, for review by an advertiser user. The operation of the analytics system 180 is described in more detail below.

Analytics System Operation

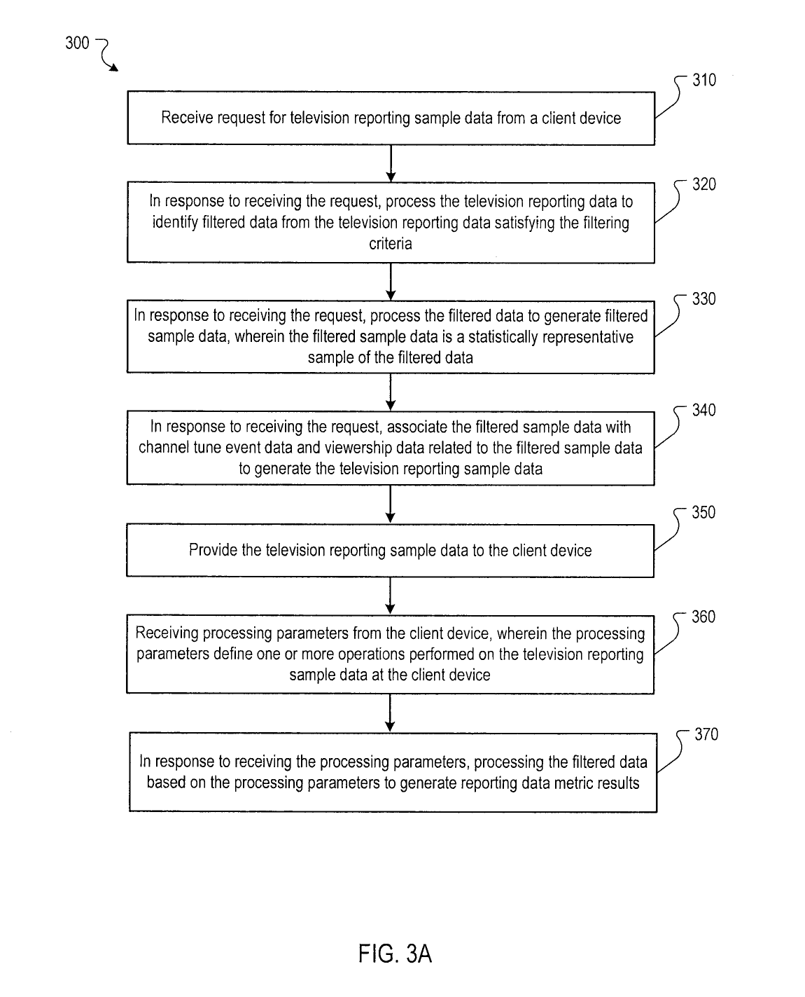

One example process by which the analytics system 180 processes and analyzes data based on processing parameters developed locally at a client device 195 is described with reference to FIG. 3A, which is a flow diagram of an example process for analyzing data.

The process 300 receives a request for television reporting sample data from a client device (310). For example, the client interface engine 212 receives the request 196 from the client device 195. The television reporting sample data is a subset of the television reporting data. The television reporting data is relatively unstructured, low-level (e.g., raw) reporting data associated with the viewing devices 165. The television reporting data is described with reference to FIG. 3B, which is an illustration of example television reporting data 380.

Television reporting data 380 include event data 382, viewership characteristic data 384 and account data 386. The event data 382 specify viewing events associated with the viewing devices 165. For example, the viewing events can include channel tune records that describe a channel change from a first channel to a second channel and the time of the change. The event data 382 can also specify unique identifiers of the viewing devices 165 associated with the various viewing events. The viewership characteristic data 384 specify characteristics of the viewers (or subscribers) using the viewing devices 165. For example, the characteristics can include demographic information about the viewers/subscribers (e.g., as determined from viewer surveys). The account data 386 specify viewing device subscriber account information. For example, the account information can include the geographic location of the viewing device 165, the type of viewing device 165 (e.g., viewing device model), and the broadcast channels subscribed to by the viewer (e.g., available for presentation of the viewing device 165). The television reporting data 380 can also include other types of information logged by a viewing device 165 or associated with viewers of the viewing devices 165.

The request received from the client device 195 (e.g., request 196) for the television reporting sample data also includes filtering criteria data. The filtering criteria data specify the criteria to be used to generate the television reporting sampling data. For example, the filtering criteria are specified by an advertiser having an account with the television advertising system 160. Advertisers' can use the filtering criteria to highlight and focus on the portions of the television reporting data they are most interested in and/or to set other constraints on the returned data set such as the size or quantity of records returned (e.g., return the event data records for ten percent of all viewing devices 165 in the system). The filtering criteria can also specify (and the television reporting sample data can include) results for requested performance metrics (e.g., the number of viewing devices 165 that presented broadcast program Y).

The television reporting sample data is a filtered, sampled, and ordered subset of the television reporting data 380 as described in more detail below with reference to process steps 320, 330 and 340, respectively.

The process 300, in response to receiving the request, processes the television reporting data to identify filtered data from the television reporting data satisfying the filtering criteria (320). For example, the television reporting data engine 214 can process the television reporting data 380 to identify filtered data from the television reporting data 380 satisfying the filtering criteria. An advertiser can, for example, select filtering criteria (e.g., set data filters) to cause the television reporting data engine 214 to identify only that data in the television reporting data that is associated with 18-34 year old males in Cleveland, OH, who subscribe to Broadcast Network X. In some implementations, the television reporting data engine 214 receives the request 196 from the client device 195, via the client interface engine 212. The television reporting data engine 214 accesses or queries the shard servers 191 (or directs the television reporting data aggregator 190) to identify the data in the television reporting data 380 that matches or satisfies the filtering criteria (i.e., the filtered data).

Given that the television reporting data 380 is likely a large set of data (e.g., reporting data from millions of viewing devices 165), the filtered data is also likely to be a large data set. For example, if the filtering criterion is all viewing devices tuned to channel tune Y at 8PM (which corresponds with the airing of a show typically viewed by 25% of the population) and the viewing device population is ten million, then the filtered data may include records for two and one half million viewing devices 165. Such large data sets are not conveniently transferrable to remote client devices 195.

The process 300 processes the filtered data to generate filtered sample data (330). In some implementations, the filtered sample data is a statistically representative sample of the filtered data. For example, the television reporting data engine 214 can process the filtered data to generate filtered sample data to reduce the quantity of data transmitted to the client device 195, as described in more detail below. The sample data is statistically representative of the source data if the relationships specified by data in the sample data are also specified or substantially specified by the data in the source data (e.g., as determined by a statistical confidence or validity measure).

In some implementations, as described above, the television reporting data aggregator 214 uses hash functions to allocate datasets (e.g., a set of data related to a particular viewing device 165) to particular shared servers 191. The filtered sample data can be identified by evenly sampling data stored in the shard servers 191 and then selecting a proportion of the data within each of those shard servers 191 using a suitable stochastic sampling mechanism. Further, in some scenarios, rather than sampling data across numerous shard servers 191, the data in any one shard server 191 can be sampled to generate the filtered sample data (e.g., assuming the data in the shard server 191 is sufficient to be statistically representative of the requested data). As described below, the statistical validity of this sampled data can be measured and passed to the user receiving the television reporting sample data so that the user can determine if the user requires a larger sample data set.

The process 300 associates the filtered sample data with channel tune event data and viewership data related to the filtered sample data to generate the television reporting sample data (340). For example, the television reporting data engine 214 can associate or join the filtered sample data with channel tune event data 382 and viewership data 384 related to the filtered sample data.

As described above, the television reporting data 380 can be relatively unstructured, and, hence, the filtered sampled data can also relatively unstructured. By associating the filtered sample data with related event data 382 and viewership data 384 (and any other data related to the filtered sample data such as related account data 386 or requested performance metrics), the television reporting data engine 214 combines and organizes all data from the television reporting data 380 related to the filtered data.

The amalgamated and organized data is the television reporting sample data. For example, the filtering criterion can be all viewing devices 165 located in New York such that the filtered sample data only includes the respective viewing device identifiers. The television reporting data engine 214 can, for example, identify all data in the television reporting data 380 that is related to viewing devices 165 in New York (e.g., channel tune states of the viewing devices from the event data 382 and demographic information associated with the subscribers to whom the viewing devices are registered from the viewership characteristic data 384). Further, the television reporting data engine 214 can, for example, organize this amalgamated data into a structured form such as a spreadsheet with each row corresponding to a unique viewing device 165 and each column corresponding to related data (e.g., events from the event data 382 and viewership information from the viewership characteristic data 384).

In some implementations, the advertiser user, via client device 195, may direct the television reporting data engine 214 (e.g., through data in request 196) not to associate the filtered sample data with related data but, rather, simply return to the user the filtered sample as the television reporting sample data. For example, the user may desire to manipulate the filtered sample data in unaltered form on the client device 195. Further, the user can specify preferences that only certain types of related data be associated with the filtered sample data (e.g., event data 382 or particular portions of the event data 382). These sample data preferences can be included in the filtering criteria and specify a preferred data subset of the channel tune data and the viewership data to associate with the filtered sample data (e.g., associate the filtered sample data with only the preferred data subset). For example, the user may specify, via request 196 from client device 195, that only demographic data should be associated or joined to the data specifying identifiers of viewing devices in New York. Thus, the television reporting sample data, for example, would only include demographic data in the columns of the spreadsheet.

The process 300 provides the television reporting sample data to the client device (350). For example, the client interface engine 212 can transmit the television reporting sample data to client device 195 as response 197. In some scenarios the television reporting sample data is a sample (e.g., fraction) of the originally requested data from request 196 (e.g., if the originally requested data is greater than some data size threshold set by the system 180 or the user). As such, the transmission of the television reporting sample data to the client device 195, as opposed to the filtered data, lessens the burden on the communication infrastructure (e.g., requires less bandwidth) and increases the timeliness of the delivery of the data to the client device 195.

The format of the television reporting sample data can be controlled by the television reporting data engine 214. For example, the television reporting data engine 214 can generate the television reporting sample data in the format of a CSV (comma separated value) file or the like, or in a format requested by the user. The television reporting sample data can also include data that specifies the IDs of the various data sets or types (e.g., column headers specifying event types or account information).

The user can analyze the television reporting sample data, for example, on an analysis tool resident on or accessible through the client device (e.g., a spreadsheet application or a dedicated data analysis application). As described above, the user can, for example, perform exploratory analysis on the television reporting sample data to develop and refine queries (e.g., processing parameters) that provide the desired insight into the television reporting sample data locally on the client device. In some implementations, the data analysis tools can be web based tools provided to the client device 195 by the analytics system 180.

In some scenarios, a user (e.g., advertiser) may want to join or aggregate other data (advertiser data or user data) with the television reporting sample data and analyze this aggregated data. However, the advertiser may not want to share the advertiser data with others (e.g., the advertiser data may be subject to confidentiality obligations or the advertiser may consider the data confidential). Thus, even though advertiser desires to include the advertiser data in the analysis, the advertiser is restricted from sharing or otherwise compelled not to share the advertiser data with the analytics system 180. Further, the analytics system 180 may not be able to readily accept the advertiser data even if the advertiser desired to join the advertiser data with the television reporting data managed by the analytic system 180. For example, because of the highly-encoded form of the television reporting data and the difficulty of translating and integrating the advertiser data into a suitable form the system 180 may not be able to easy join the two data sets. As such for multiple reasons, the advertiser data may not be able to be shared or utilized by the analytics system 180.

Advantageously, these issues can be addressed by joining the advertiser data and television reporting sample data at the client device 195. Particularly, the advertiser can utilize analytics tools on the client device 195 to locally join the advertiser data with the television reporting sample data. For example, an advertiser may have viewership survey results from young professionals in New York city that include details not available in the television reporting data (e.g., annual salary, recent purchasing decisions, etc.) and the advertiser may want to include this survey data in the analysis. The advertiser can utilize analytics tools on the client device 195 to join the survey results data with the television reporting sample data.

Joining the data sets at the client device 195 can be accomplished in numerous ways. For example, if the television reporting sample data are provided in a CSV format and the advertiser data are also in a CSV format the advertiser can “merge” the two data sets/files together at the client device 195. Joining the advertiser data and the television reporting sample data is aided by the IDs of the various data sets or types (e.g., column headers) being included in the television reporting sample data and the flexibility of the analytics system 180 in generating the television reporting sample data in common or user-specified formats.

Process 300 receives processing parameters from the client device (360). The processing parameters define one or more operations performed on the television reporting sample data (or the television reporting data 380 and the advertiser data) at the client device 195. For example, an advertiser may develop a set of filters, metric computation parameters or queries that obtain a desired insight in to the data under review. This may be a trial and error process. For example, the advertiser may develop a set of processing parameters to identify all viewing devices 165 that presented a promotional advertisement for a broadcast program twice and that presented the broadcast program. Because the television reporting data aggregator 190 stores the television reporting data 380 in a low-level form (.e.g., as raw data) new performance metrics based on the processing parameters can be readily generated from this low-level data. In some implementations, the client interface engine 212 receives processing parameters (e.g., request 198) from the client device 195.

Depending on the tool(s) on the client device 195 used by the advertiser to generate the processing parameters, the parameters may include database query instructions in a query language that is not interpretable by the analytics system 180. For example, the processing parameters may be in a first query language and the analytics system 180 may only understand query instructions in a second language. The television reporting data engine 214 can translate the database query instructions in the first query language (e.g., from the processing parameters) to database query instructions in the second query language so that the instructions are understood by the analytics system 180. In some implementations, the translations process is performed by an API provided by the television reporting data engine 214.

The processing parameters can also include a list of viewing device identifiers (e.g., viewing device identifier data such as a subset of unique viewing device identifiers) that, for example, are of particular interest to the advertiser. The analytics system 180, for example, can use this list to restrict its analysis to only data associated with the population defined by the list and generate results data from the television reporting data related to only the viewing devices specified in the viewing device identifier data. In other words, the analytics system 120 will process only the data corresponding to the unique identifiers. For example, the television reporting sample data can include data for all viewing devices 165 in New York (e.g., based on the filtering criteria), the advertiser may join the survey data from the survey results of young professional in New York with the television reporting sample data.

Through the advertiser's analysis of this aggregate data the advertiser, for example, identifies a particular group of young professionals from the advertiser data who are of particular interest and are also subscribers with corresponding viewing device 165 records in the television reporting sample data. The advertiser can, for example, cause the request 198 to include data that restricts the analysis of the analytics system 180 to only television reporting data associated with the viewing device 165 identifiers of the group of young professionals. Because this group of young professionals is not a separate or distinct group (e.g., not a particular demographic) already recognized in the analytics system 180, it is not otherwise a trivial matter to query or filter the television reporting data 380 so that the analytics system 180 only processes the reporting data 380 for this group.

In some implementations, the client device 195 provisions the list of unique viewing device 165 identifiers to the analytics system 180 by, for example, executing an HTTP POST operation to a known URL with the contents of the list in a standard form (e.g., CSV). The analytics system 180 receives the list and allocates the list a universally unique identifier (UUID) or handle, and stores the handle in a semi-persistent location (e.g., stores the list for 24 hours).

The analytics system 180 also returns the handle to the client device 195 so that the client device 195 can use the handle as a reference for the list for any subsequent analysis requests concerning the list (e.g., instead of sending the list again). After the handle has been discarded by the analytics system 180 (e.g., as the handle is only stored in semi-persistent storage) and client device 195 requests an analysis concerning the list, the client device 195 can simple transmit the list again to the system 180. Thus, the analytics system 180 can remain largely stateless.

In further implementations, the above handling process can be applied on a server-to-server basis in which the client device 195 provides data to the analytics system 180 instructing the analytics system 180 to cache the outputs of any filtering operations performed by the system 180 in response to requests (e.g., request 196) from the client device 195. In this case, the unique identifiers identified from the filtering process are not transferred to the client device 195. Rather, the identifiers are interned at the system 180, allocated a UUID and the allocated UUID is returned to the client device 195 for reference for future operations concerning the viewing devices 165 related to the filtered data. In this way a client device 195 can, for example, break the filtering operation into stages, can link the outputs of stages to the inputs of other stages, and can check-point large operations at the analytics system 180.

The process 300, in response to receiving the processing parameters, processes the filtered data based on the processing parameters to generate reporting data metric results (370). Reporting data metric results (or results data) are results from performing the operations specified by the processing parameters on the filtered data, or, in some cases, on other portions or the entirety of the television reporting data 380. The reporting data metric results include, for example, the dimensions over which the results are reported (e.g., per-viewing device; per-subscriber account, which may include multiple viewing devices; to per-demographic market area; etc.).

In some implementations, the television reporting data engine 214 processes (or causes the television reporting data aggregator 190 to process) the filtered data based on the processing parameters to generate reporting data metric results. The reporting data metric results can be returned to the client device 190 in response 199 (e.g., by the client interface engine 212). In some implementations, the reporting data metrics indicate the full measure of precision for the requested metrics as the reporting data metrics are based on an analysis of the entire relative data population (e.g., the filtered data or all of the television reporting data), as opposed to the analysis performed on the client device 195 based on only the television reporting sample data, which is a subset of the filtered data or all of the television reporting data. However, in some scenarios, the data set size of the television reporting sample data may be large enough that the advertiser is confident in results obtained from that sample data set without further confirmation from an analysis performed by the analytic system 120 on a larger data set (e.g., as indicated by the confidence data described below).

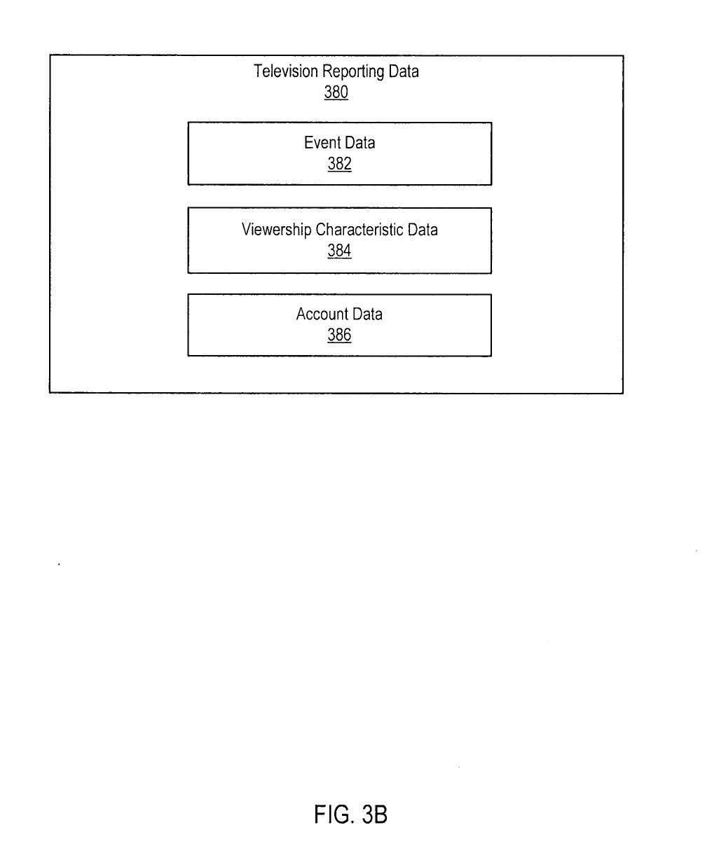

One example process by which a client device 195 generates processing parameters for use by the analytics system 180 is described with reference to FIG. 4, which is a flow diagram of an example process for generating processing parameters.

The process 400 generates a request for television reporting sample data at a client device (410). For example, the client device 195 generates a request for television reporting sample data. The request includes filtering criteria and the television reporting sample data is a subset of television reporting data (e.g., television reporting data 380).

The process 400 provides the request for the television reporting sample data to an analytics system (420). For example, the client device 195 provides the request for the television reporting sample data to the analytics system 180. The filtering criteria are useable by the analytics system 180 to process the television reporting data to generate the television reporting sample data.

The process 400 receives the television reporting sample data from the analytics system (430). For example, the client device 195 can receive the television reporting sample data generated by the analytics system 180 (e.g., as described with reference to process 300).

The process 400 determines processing parameters at the client device that define one or more operations performed on the television reporting sample data by the client device (440). For example, the client device 195 determines the processing parameters.

The process 400 provides the processing parameters to the analytics system (450). For example, the client device 195 can provide the processing parameters to the analytics system 180. The processing parameters are usable by the analytics system 180 to process the television reporting data (e.g., as described with reference to process 300).

The process 400 receives results data at the client device from the analytics system (460). For example, the client device 195 receives results data from the analytics system 180. The analytics systems 180 can, for example, generate the results data as described with reference to process 300. The results data specify the results (e.g., reporting data metric results) from processing the television reporting data based on the processing parameters.

Confidence Data Generation

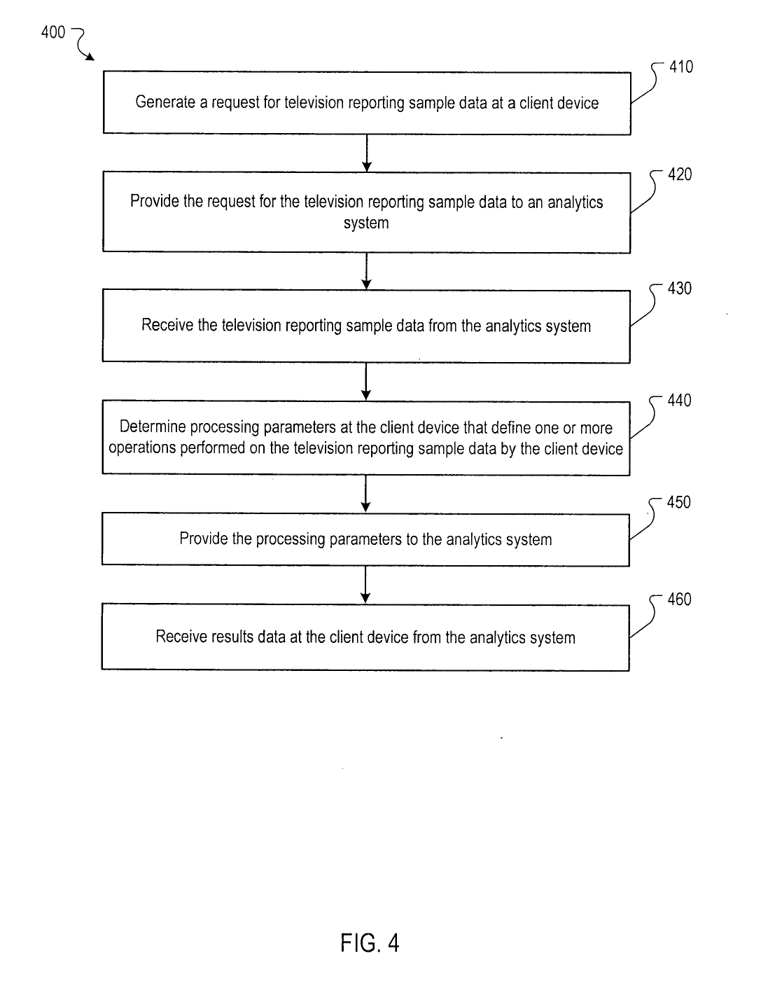

As described above, the television reporting sample data is derived from filtered sample data, which is a sample or subset of the filtered data generated in accordance with the filtering criteria received from the client device 195. The filtered data is sampled because it usually represents a large dataset that is not conveniently transmittable to the remote client devices 195. As such, the smaller data set of the filtered sample data is generated and sent to the client device 195. However, in some cases the sampling process may introduce some statistical variance into the sampled data set (e.g., the possibility that the sampled data does not reflect every data attribute and feature included in the data from which the sample was taken). The provision of the statistical validity measure of the television reporting data to a user can be described with reference to FIG. 5, which is flow diagram of an example process for providing confidence data.

The process 500 generates confidence data specifying a measure of a statistical validity of the filtered sample data with respect to the filtered data (510). For example, the television reporting data engine 214 can generate the confidence data or can receive the confidence data from the television reporting data aggregator 190. The confidence data specify a quality measure of the statistical representation of the filtered sample data (and hence the television reporting sample data) of the filtered data. This measure can be quantified by, for example, error bars or other statistical validity techniques. For example, the measure of statistically validity can be based on the statistical validity of calculated performance metric results included in the filtered sample data, as specified in the filtering criteria data.

The process 500 provides the confidence data to the client device (520). For example, the client interface engine 212 provides the confidence data to the client device 195 along with the television reporting sample data. This quantification allows the user of the client device 195 to evaluate whether the accuracy of the sampled data is sufficient for the user's purposes.

The process 500 receives indication data specifying that the measure of statistical validity is not within a threshold range (530). For example, the client interface engine 212 receives the indication data from the client device 195, at the direction of the user. The user, through the client device 195, can send the indication data if the user evaluates the statistical measure and determines that the measure is in the confidence range desired by the user (e.g., the threshold range).

The process 500, in response to receiving the indication data, processes the filtered data to generate second filtered sample data having more data than the filtered sample data (540). For example, the television reporting data engine 214 can process the filtered data (again) to generate the second filtered sample data set, which is larger than the filtered sample data set (i.e., contains more data than the filtered sample data set). In this way, the user, via the client device 195 can request, if available, a larger sampled data set for analysis (e.g., the larger sample data set likely to be a better representation of the source data).

Although this written description has described methods, software and systems for processing and analyzing television reporting data in an online analytics system (e.g., web-based analytics system), the methods, software and systems can also be used to process and analyze other types of data.

Additional Implementation Details

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

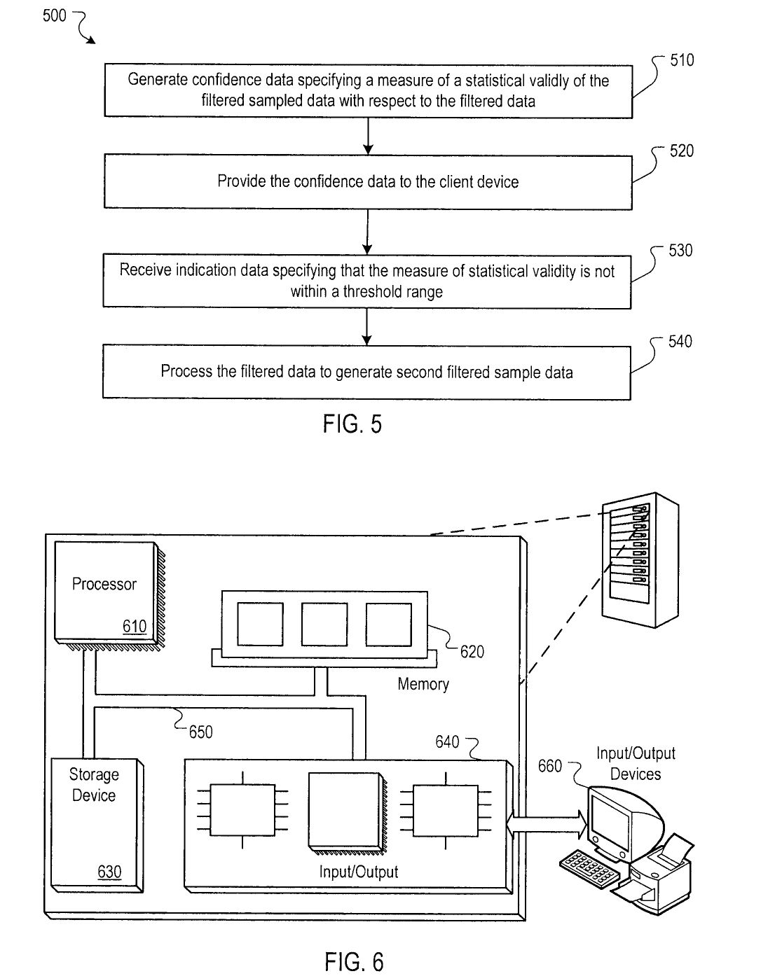

An example of one such type of computer is shown in FIG. 6, which shows a block diagram of a programmable processing system (system). The system 600 that can be utilized to implement the systems and methods described herein. The architecture of the system 600 can, for example, be used to implement a computer client, a computer server, or some other computer device.

The system 600 includes a processor 610, a memory 620, a storage device 630, and an input/output device 640. Each of the components 610, 620, 630, and 640 can, for example, be interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can, for example, include a hard disk device, an optical disk device, or some other large capacity storage device.

The input/output device 640 provides input/output operations for the system 600. In one implementation, the input/output device 640 can include one or more of a network interface device, e.g., an Ethernet card, a serial communication device, e.g., and RS-232 port, and/or a wireless interface device, e.g., an 802.11 card. In another implementation, the input/output device can include driver devices configured to receive input data and send output data to other input/output devices, e.g., keyboard, printer and display devices 660.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving, at one or more processors, a request for television reporting sample data from a client device of an advertiser, wherein the request includes filtering criteria and the television reporting sample data is a subset of television reporting data, the television reporting data comprising channel tune event data specifying channel tune states of viewing devices at certain times and viewership data specifying viewership characteristics associated with the viewing devices;
in response to receiving the request:
processing the television reporting data to identify filtered data from the television reporting data satisfying the filtering criteria;
processing the filtered data to generate filtered sample data, wherein the filtered sample data is a statistically representative sample of the filtered data;
associating the filtered sample data with channel tune event data and viewership data related to the filtered sample data to generate the television reporting sample data;
providing the television reporting sample data to the client device;
receiving, at the one or more processors, processing parameters from the client device, wherein the processing parameters define one or more operations performed on the television reporting sample data at the client device; and
in response to receiving the processing parameters, processing the filtered data based on the processing parameters to generate reporting data metric results.

2. The method of claim 1, wherein the processing parameters comprise unique identifiers of a subset of the viewing devices; and
processing the filtered data based on the processing parameters comprises processing only the filtered data corresponding to the unique identifiers.

3. The method of claim 1, wherein the filtering criteria comprise sample data preferences specifying a preferred data subset of the channel tune data and the viewership data; and
associating the filtered sample data with channel tune event data and viewership data related to the filtered sample data comprises associating the filtered sample data with only the preferred data subset.

4. The method of claim 1, further comprising:
generating confidence data specifying a measure of a statistical validity of the filtered sample data with respect to the filtered data; and
providing the confidence data to the client device.

5. The method of claim 4, further comprising:
receiving indication data specifying that the measure of statistical validity is not within a threshold range; and
in response to receiving the indication data, processing the filtered data to generate filtered sample data comprises processing the filtered data to generate second filtered sample data having more data than the filtered sample data.

6. The method of claim 1, wherein the one or more operations of the processing parameters specify database query instructions, and receiving the processing parameters comprises receiving the database query instructions in a first query language, the method further comprising:
translating the database query instructions in the first query language to database query instructions in a second query language.

7. A computer-implemented method, comprising:
generating a request for television reporting sample data at a client device of an advertiser, wherein the request includes filtering criteria and the television reporting sample data is a subset of television reporting data, the television reporting data comprising channel tune event data specifying channel tune states of viewing devices at certain times and viewership data specifying viewership characteristics associated with the viewing devices;
providing the request for the television reporting sample data to an analytics system, wherein the filtering criteria are useable by the analytics system to process the television reporting data to generate the television reporting sample data;
receiving the television reporting sample data from the analytics system;
determining processing parameters at the client device that define one or more operations performed on the television reporting sample data by the client device;
providing the processing parameters to the analytics system, wherein the processing parameters are usable by the analytics system to process the television reporting data based on the one or more operations; and
receiving results data at the client device from the analytics system, the results data specify results from processing the television reporting data based on the one or more operations.

8. The method of claim 7, further comprising:
accessing user data at the client device, wherein the user data is different from the television reporting data;
aggregating the user data and the television reporting sample data at the client device;
identifying at the client device viewing device identifier data specifying unique identifiers of a subset of viewing devices specified in the aggregated user and television reporting sample data; and
providing the viewing device identifier data to the analytics system, wherein the viewing device identifier data is usable by the analytics system to generate results data related to only the viewing devices specified in the viewing device identifier data.

9. The method of claim 7, wherein the analytics system is a web based analytics system.

10. A system comprising:
a data processing apparatus; and
software stored on a computer storage apparatus and comprising instructions executable by the data processing apparatus and upon such execution cause the data processing apparatus to perform operations comprising:
receiving a request for television reporting sample data from a client device of an advertiser, wherein the request includes filtering criteria and the television reporting sample data is a subset of television reporting data, the television reporting data comprising channel tune event data specifying channel tune states of viewing devices at certain times and viewership data specifying viewership characteristics associated with the viewing devices;
in response to receiving the request:
processing the television reporting data to identify filtered data from the television reporting data satisfying the filtering criteria;
processing the filtered data to generate filtered sample data, wherein the filtered sample data is a statistically representative sample of the filtered data;
associating the filtered sample data with channel tune event data and viewership data related to the filtered sample data to generate the television reporting sample data;
providing the television reporting sample data to the client device;
receiving processing parameters from the client device, wherein the processing parameters define one or more operations performed on the television reporting sample data at the client device; and
in response to receiving the processing parameters, processing the filtered data based on the processing parameters to generate reporting data metric results.

11. The system of claim 10, wherein the processing parameters comprise unique identifiers of a subset of the viewing devices; and
processing the filtered data based on the processing parameters comprises processing only the filtered data corresponding to the unique identifiers.

12. The system of claim 10, wherein the filtering criteria comprise sample data preferences specifying a preferred data subset of the channel tune data and the viewership data; and
associating the filtered sample data with channel tune event data and viewership data related to the filtered sample data comprises associating the filtered sample data with only the preferred data subset.

13. The system of claim 10, wherein upon execution of the instructions the data processing apparatus further performs operations comprising:
generating confidence data specifying a measure of a statistical validity of the filtered sample data with respect to the filtered data; and
providing the confidence data to the client device.

14. The system of claim 13, wherein upon execution of the instructions the data processing apparatus further performs operations comprising:
receiving indication data specifying that the measure of statistical validity is not within a threshold range; and
in response to receiving the indication data, processing the filtered data to generate filtered sample data comprises processing the filtered data to generate second filtered sample data having more data than the filtered sample data.

15. A non-transitory computer storage medium encoded with a computer program, the program comprising instructions that when executed by a data processing apparatus cause the data processing apparatus to perform operations, comprising:
receiving a request for television reporting sample data from a client device of an advertiser, wherein the request includes filtering criteria and the television reporting sample data is a subset of television reporting data, the television reporting data comprising channel tune event data specifying channel tune states of viewing devices at certain times and viewership data specifying viewership characteristics associated with the viewing devices;
in response to receiving the request:
processing the television reporting data to identify filtered data from the television reporting data satisfying the filtering criteria;
processing the filtered data to generate filtered sample data, wherein the filtered sample data is a statistically representative sample of the filtered data;
associating the filtered sample data with channel tune event data and viewership data related to the filtered sample data to generate the television reporting sample data;
providing the television reporting sample data to the client device; receiving processing parameters from the client device, wherein the processing parameters define one or more operations performed on the television reporting sample data at the client device; and
in response to receiving the processing parameters, processing the filtered data based on the processing parameters to generate reporting data metric results.

16. The non-transitory computer storage medium of claim 15, wherein the processing parameters comprise unique identifiers of a subset of the viewing devices; and processing the filtered data based on the processing parameters comprises processing only the filtered data corresponding to the unique identifiers.

17. The non-transitory computer storage medium of claim 15, wherein the filtering criteria comprise sample data preferences specifying a preferred data subset of the channel tune data and the viewership data; and
associating the filtered sample data with channel tune event data and viewership data related to the filtered sample data comprises associating the filtered sample data with only the preferred data subset.

18. The non-transitory computer storage medium of claim 15, wherein the program further comprises instructions that when executed by the data processing apparatus cause the data processing apparatus to perform operations, comprising:
generating confidence data specifying a measure of a statistical validity of the filtered sample data with respect to the filtered data; and
providing the confidence data to the client device.

19. A system comprising:
a data processing apparatus; and
software stored on a computer storage apparatus and comprising instructions executable by the data processing apparatus and upon such execution cause the data processing apparatus to perform operations comprising:
generating a request for television reporting sample data at a client device of an advertiser, wherein the request includes filtering criteria and the television reporting sample data is a subset of television reporting data, the television reporting data comprising channel tune event data specifying channel tune states of viewing devices at certain times and viewership data specifying viewership characteristics associated with the viewing devices;
providing the request for the television reporting sample data to an analytics system, wherein the filtering criteria are useable by the analytics system to process the television reporting data to generate the television reporting sample data;
receiving the television reporting sample data from the analytics system;
determining processing parameters at the client device that define one or more operations performed on the television reporting sample data by the client device;
providing the processing parameters to the analytics system, wherein the processing parameters are usable by the analytics system to process the television reporting data based on the one or more operations; and
receiving results data at the client device from the analytics system, the results data specify results from processing the television reporting data based on the one or more operations.

20. The system of claim 19, wherein upon execution of the instructions the data processing apparatus further performs operations comprising:
accessing user data at the client device, wherein the user data is different from the television reporting data;
aggregating the user data and the television reporting sample data at the client device;
identifying at the client device viewing device identifier data specifying unique identifiers of a subset of viewing devices specified in the aggregated user and television reporting sample data; and
providing the viewing device identifier data to the analytics system, wherein the viewing device identifier data is usable by the analytics system to generate results data related to only the viewing devices specified in the viewing device identifier data.
